(19) United States
(12) Patent Application Publication
(10) Pub. No.: US 2017/0168696 A1
(43) Pub. Date: Jun. 15, 2017

(54) METHOD AND ELECTRONIC DEVICE FOR ADJUSTING VIDEO WINDOW BASED ON MULTI-POINT CONTROL

(71) Applicants: Le Holdings (Beijing) Co., Ltd., Beijing (CN); Le Shi Zhi Xin Electronic Technology (Tianjin) Limted, Tianjin (CN)

(72) Inventors: Yingjie LI, Tianjin (CN); Hua KANG, Tianjin (CN); Shuilong YU, Tianjin (CN); Xun XU, Tianjin (CN)

(21) Appl. No.: 15/250,757

(22) Filed: Aug. 29, 2016

Related U.S. Application Data
(63) Continuation of application No. PCT/CN2016/088656, filed on Jul. 5, 2016.

(30) Foreign Application Priority Data
Dec. 14, 2015 (CN) 201510944257.7

(51) Int. Cl. G06F 3/0484; G06F 3/0488; G06F 3/041

(52) U.S. Cl. CPC G06F 3/04847; G06F 3/041; G06F 3/0488; G06F 3/04845; G06F 2203/04104; G06F 2203/04806; G06F 2203/04808; H04N 7/141

(57) ABSTRACT

A method for adjusting a video window based on multi-touch control and an electronic device thereof is disclosed. The method includes: receiving a touch control signal, determining that the touch control signal is a multi-touch control signal, and determining that start positions of at least two-touch control signals in the multi-touch control signal are located with the video window; acquiring touch control operations of a user in at least two different directions, the touch control operations in at least two different directions including a first operation and a second operation; and dragging and zooming the video window according to the touch control operations in the two different directions. With the method and device for adjusting a video window based on multi-touch control according to the embodiment of the present disclosure, touch control stretching and zooming of the size and position of a small window during video calls are monitored, such that the video calls are simpler, and thus the user may make more humanized feedbacks according to the user's operations as desired.

### CROSS-REFERENCE TO RELATED APPLICATIONS

This application is a continuation of PCT Application No. PCT/CN2016/088656, filed on Jul. 5, 2016, which claims priority to Chinese Patent Application No. 201510944257.7, filed before State Intellectual Property Office of the P. R. China on Dec. 14, 2015 and entitled “METHOD AND ELECTRONIC DEVICE FOR ADJUSTING VIDEO WINDOW BASED ON MULTI-POINT CONTROL”, the entire contents of which are incorporated herein by reference.

### TECHNICAL FIELD

The present disclosure relates to the technical field of man-machine interaction, and more particularly, to a method and device for adjusting a video window based on multi-touch control.

### BACKGROUND

The touch control technology is well known among people, and most ATMs deployed in the banks are provided with a touch screen, and computers equipped with such touch control technology are deployed in halls of most hospitals, libraries and the like. In addition, many mobile phones, MP3s and digital cameras are provided with a touch screen. However, the conventional touch screens all support single-touch control, and are only capable of identifying and supporting a touch control or a tap of one finger at each time. If at least two points on the screen are touched, the touch screen may not make a correct response. The multi-touch control technology divides a task into two aspects. One is simultaneously collecting multi-touch signals, and the other is judging the intention of each signal, that is, gesture identification. In this way, the screen may identify taps and touch control operations simultaneously performed by five fingers of a user.

The touch control technology achieves a friendly, visual, convenient and simple user interface, and has become one of the most popular man-machine interface technologies, especially, the touch control technology capable of implementing multi-touch control identification. The touch control technology is a technology in which a touch control panel senses a touch object (for example, the finger of a user) and hence acquires an operation and control action that the user intended to perform. Before implementation of multi-touch control, a first thing is to judge whether touch control of a user is a single-finger touch control event or a multi-touch control event. Upon the judgment, touch control that the user intends to perform may be analyzed correctly according to processing rules respectively corresponding to the single-finger touch control event and the multi-touch control event.

Emergence of the multi-touch control is another thorough upgrade of the user control interface upon emergence of the mouse. In such new user interface, full control may be implemented by fingers under the assistance of an innovative software support and a super-large multi-touch screen.

At present, the touch control technology is widely applied in portable devices, and applications on the future portable devices tend to be controlled by the touch control. Currently, the picture browser, the webpage browser and the like functions that are used by users on many portable products are implemented based on the multi-touch control technologies. Therefore, a video player based on the multi-touch control may best improve user experience.

With the popularity and speed improvement of 4G networks, people are communicating with each other via the network, for example, WeChat and QQ, via which texts, audios and even videos may be sent. Video calls are particularly convenient, which may narrow the distance of people who are in remote places. With the improvement of network access speed of mobile devices with advancement of science and technology, video calls would be more popular among people. Therefore, human-orientation of interactions between the video call interface and human are especially important.

At present, operations on video images by video call applications may monitor single-finger touch control of the users, and move with the movement of the fingers. During implementation of the present disclosure, the inventors have identified that the technical problem in the conventional solution is that the played video may not be zoomed in and zoomed out according to the touch control of the fingers of the user, and thus the man-machine interaction is not human-orientated.

### SUMMARY

The present disclosure provides a method and electronic device for adjusting a video window based on multi-touch control. With the method and electronic device, during a video call, video display may be zoomed out and in or moved with touch control by a finger of a user, thereby improving smartness of a man-machine interaction interface.

Embodiments of the present disclosure provide a method for adjusting a video window based on multi-touch control. The method includes:

receiving a touch control signal, determining that the touch control signal is a multi-touch control signal, and determining that start positions of at least two-touch control signals in the multi-touch control signal are located within the video window;

acquiring touch control operations of a user in at least two different directions, the touch control operations in at least two different directions comprising a first operation and a second operation; and

dragging and zooming the video window according to the touch control operations in the two different directions.

Embodiments of the present disclosure further provide a non-volatile computer storage medium storing computer executable instructions, wherein the computer executable instructions may be used to perform any one method for adjusting a video window based on multi-touch control as defined in the present disclosure.

Embodiments of the present disclosure further provide an electronic device. The electronic device includes: at least one processor; and a memory communicably connected to the at least one processor; wherein the memory stores instructions executable by the at least one processor, wherein, the instructions, when being executed by the at least one processor, cause the at least one processor to perform the method for adjusting a video window based on multi-touch control as described above according to the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for adjusting a video window based on multi-touch control according to some embodiments of the present disclosure;

FIG. 2 is a flowchart illustrating a method for adjusting a video window based on multi-touch control according to some embodiments of the present disclosure;

FIG. 3 is a flowchart illustrating a method for adjusting a video window based on multi-touch control according to some embodiments of the present disclosure;

FIG. 4 is a flowchart illustrating a method for adjusting a video window based on multi-touch control according to some embodiments of the present disclosure;

FIG. 5 is a flowchart illustrating a method for adjusting a video window based on multi-touch control according to some embodiments of the present disclosure;

FIG. 6 is a schematic structural diagram illustrating an electronic device for use in adjusting a video window based on multi-touch control according to some embodiments of the present disclosure;

FIG. 7 is a schematic structural diagram illustrating an electronic device for use in adjusting a video window based on multi-touch control according to some embodiments of the present disclosure;

FIG. 8 is a schematic structural diagram illustrating an electronic device for use in adjusting a video window based on multi-touch control according to some embodiments of the present disclosure;

FIG. 9 is a schematic structural diagram illustrating an electronic device for use in adjusting a video window based on multi-touch control according to some embodiments of the present disclosure;

FIG. 10 is a schematic structural diagram illustrating an electronic device for use in adjusting a video window based on multi-touch control according to some embodiments of the present disclosure; and

FIG. 11 is a schematic structural diagram illustrating hardware of an electronic device for performing the method for adjusting a video window based on multi-touch control according to some embodiments of the present disclosure.

### DETAILED DESCRIPTION

To make the objectives, technical solutions and advantages of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

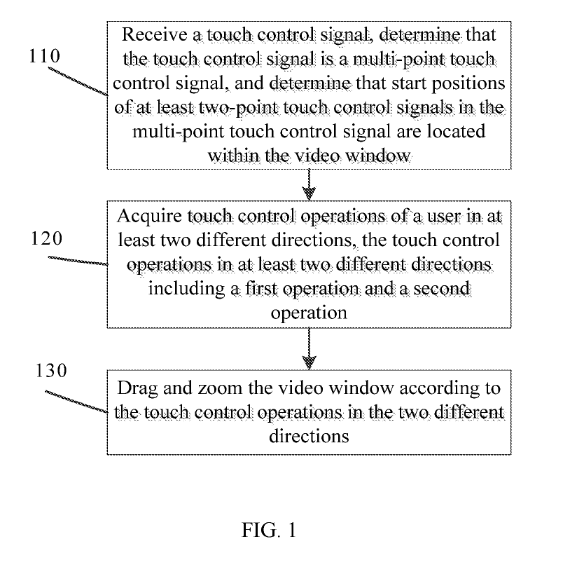

FIG. 1 is a flowchart illustrating a method for adjusting a video window based on multi-touch control according to some embodiments of the present disclosure. As illustrated in FIG. 1, the method for adjusting a video window based on multi-touch control according to the embodiment of the present disclosure includes the following steps:

Step 110: A touch control signal is received, it is determined that the touch control signal is a multi-touch control signal, and it is determined that start positions of at least two-touch control signals in the multi-touch control signal are located within the video window.

A touch control panel is embedded with a plurality of sensing electrodes to provide a plurality of inductances (for example, capacitance variations), and the touch control panel receives touch control signals by means of sensing taps, which may be implemented according to the related art. In this step, it needs to determine that a plurality touch control signals are received, determine that the touch control signals are multi-touch control information, and determine that start positions of at least two-touch control signals in the multi-touch control signal are located with the video window.

Specifically, two video windows may be present in the touch control panel. For example, a large video window is used for displaying video information of two parties of a video call, and a small video window is used for displaying video signals at a local end of the video call. When a user needs to adjust the small video window, the user needs to perform at least two touch controls in the small video window, that is, start positions of at least two-touch control signals are located within the small video window. When at least two-touch control signals fall within the range of the large video window instead of the small video window, the large video window may be operated by using these two points.

Step 120: Touch control operations of a user in at least two different directions are acquired, wherein the touch control operations in at least two different directions include a first operation and a second operation.

It may be understood that, when at least two touch control point signals are available, the two touch control points respectively start displacement to form touch control operations in two different directions. In this step, the touch control operations of the user in at least two different directions may be acquired. In the embodiment of the present disclosure, for differentiation in description, the two touch control operations in the at least two different directions may be referred to a first operation and a second operation. In the description hereinafter, it may be understood that the first operation and the second operation both refer to a touch control operation of the user on a touch control panel.

Step 130: The video window is dragged and zoomed according to the touch control operations in the two different directions.

The position of the video window is changed and the video window is zoomed out or zoomed in according to the touch control operations in the at least two different directions.

For example, when two fingers of the user reside in a small video window region, and then the two fingers respectively stretch outward, the small video window region may also be extended with the touch of the fingers. When the two fingers of the user reside in a small video window region, and then the two fingers respectively shrink inward, the small video window region may also be narrowed with the touch of the fingers.

With the method for adjusting a video window based on multi-touch control according to the embodiment of the present disclosure, touch control stretching and zooming of the size and position of a small window during video calls are monitored, such that the video calls are simpler, and thus the user may make more humanized feedbacks according to the user's operations as desired.

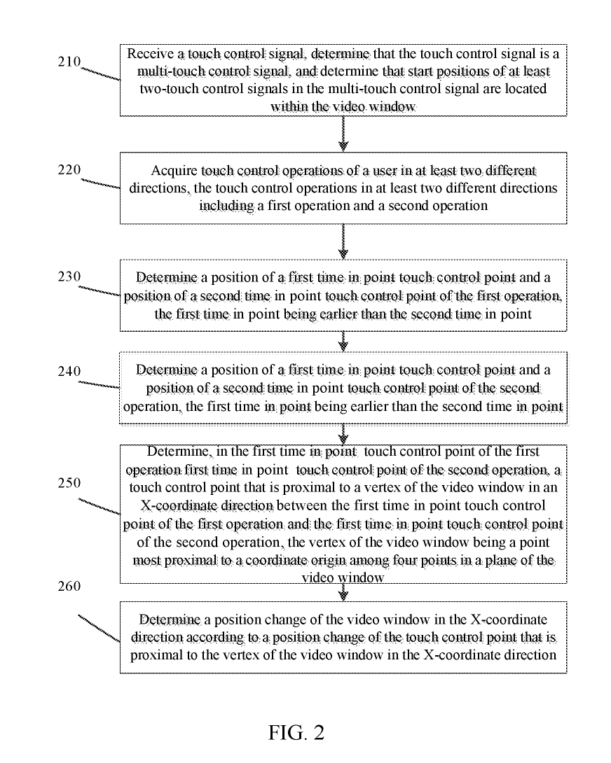

FIG. 2 is a flowchart illustrating a method for adjusting a video window based on multi-touch control according to some embodiments of the present disclosure. As illustrated in FIG. 2, the method for adjusting a video window based on multi-touch control according to the embodiment of the present disclosure includes the following steps:

Step 210: A touch control signal is received, it is determined that the touch control signal is a multi-touch control signal, and it is determined that start positions of at least two-touch control signals in the multi-touch control signal are located within the video window.

In this step, the touch control signal is received, the touch control signal is determined to be a multi-touch control signal, and it is determined that the start positions of at least two-touch control signals in the multi-touch control signal are located within the video window. Specific operations may refer to step 110 in the embodiment corresponding to FIG. 1.

Step 220: Touch control operations of a user in at least two different directions are acquired, wherein the touch control operations in at least two different directions include a first operation and a second operation.

In this step, the touch control operations of a user in at least two different directions are acquired, wherein the touch control operations in at least two different directions include a first operation and a second operation. Specific operations may refer to step 120 in the embodiment corresponding to FIG. 1.

Step 230: A position of a first time in point touch control point and a position of a second time in point touch control point of the first operation are determined, wherein the first time in point is earlier than the second time in point.

It may be understood that a plurality of touch control points with constantly changed positions form a touch control operation. When the finger of the user swipes in a video region, a plurality of touch control points are practically generated. In this step, the position of the first time in point touch control point and the position of the second time in point touch control point of the first operation are determined, wherein the first time in point is earlier than the second time in point. The direction of the first operation may be judged since the first time in point is earlier than the second time in point.

Step 240: A position of a first time in point touch control point and a position of a second time in point touch control point of the second operation are determined, wherein the first time in point is earlier than the second time in point.

In this step, the position of the first time in point touch control point and the position of the second time in point touch control point of the second operation are determined, wherein the first time in point is earlier than the second time in point. The direction of the second operation may be judged since the first time in point is earlier than the second time in point.

Step 250: A touch control point that is proximal to a vertex of the video window in an X-coordinate direction is determined in the first time in point touch control point of the first operation first time in point touch control point of the second operation, wherein the vertex of the video window is a point most proximal to a coordinate origin among four points in a plane of the video window.

In this step, the touch control point that is proximal to the vertex of the video window in the X-coordinate direction is determined in the first time in point touch control point of the first operation first time in point touch control point of the second operation, that is, a position, among the positions of the start touch control points of the two operations, which is more proximal to the vertex of the video window is determined. Alternatively, in the first operation and the second operation, at the same time point, a position, in the two operations, which is more proximal to the vertex of the video window is determined. It may be understood that the vertex of the video window is a point most proximal to a coordinate origin among four points in a plane of the video window. Specifically, the coordinate origin may be defined at the upper left corner of the display screen, and in this case, the vertex of the video window is correspondingly located at the upper left corner of the video window. However, the coordinate origin may be defined at the lower left corner of the display screen, and in this case, the vertex of the video window is correspondingly located at the lower left corner of the video window. The embodiment of the present disclosure sets no limitation thereto.

Step 260: A position change of the video window in the X-coordinate direction is determined according to a position change of the touch control point that is proximal to the vertex of the video window in the X-coordinate direction.

In this step, the position change of the video window in the X-coordinate direction is determined according to the position change of the touch control point that is proximal to the vertex of the video window in the X-coordinate direction. That is, when the touch control point that is proximal to the vertex of the video window in the X-coordinate direction moves towards a direction, the video window also moves towards to this direction. Specifically, when the touch control point that is proximal to the vertex of the video window in the X-coordinate direction moves towards a direction by a specific value, the video window also moves towards to this direction by the specific value. It may be understood that, in the present disclosure, the position change of the video window in the X-coordinate direction is determined according to a position change of the touch control point that is distal from the vertex of the video window in the X-coordinate direction. This manner is similar to the above manner. For brevity of description, this manner is not described herein in the embodiment of the present invention.

In the embodiment of the present disclosure, the position change of the video window in the X-coordinate direction is determined according to the position change of the touch control point that is proximal to the vertex of the video window in the X-coordinate direction, such that the video window is dragged by means of multi-touch control.

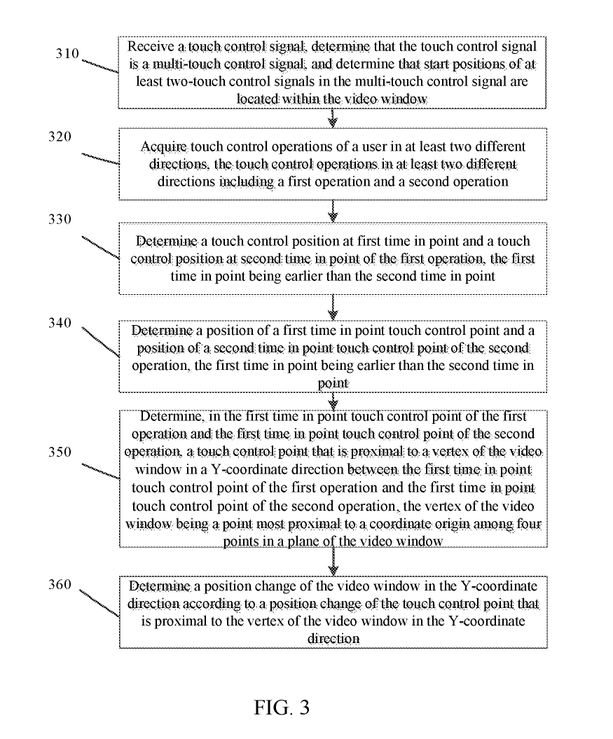

FIG. 3 is a flowchart illustrating a method for adjusting a video window based on multi-touch control according to some embodiments of the present disclosure. As illustrated in FIG. 3, the method for adjusting a video window based on multi-touch control according to the embodiment of the present disclosure includes the following steps:

Step 310: A touch control signal is received, it is determined that the touch control signal is a multi-touch control signal, and it is determined that start positions of at least two-touch control signals in the multi-touch control signal are located within the video window.

In this step, the touch control signal is received, the touch control signal is determined to be a multi-touch control signal, and it is determined that the start positions of at least two-touch control signals in the multi-touch control signal are located within the video window. Specific operations may refer to step 110 in the embodiment corresponding to FIG. 1.

Step 320: Touch control operations of a user in at least two different directions are acquired, wherein the touch control operations in at least two different directions include a first operation and a second operation.

In this step, the touch control operations of a user in at least two different directions are acquired, wherein the touch control operations in at least two different directions include a first operation and a second operation. Specific operations may refer to step 120 in the embodiment corresponding to FIG. 1.

Step 330: A position of a first time in point touch control point and a position of a second time in point touch control point of the first operation are determined, wherein the first time in point is earlier than the second time in point.

In this step, the position of the first time in point touch control point and the position of the second time in point touch control point of the first operation are determined, wherein the first time in point is earlier than the second time in point. Specific operations may refer to step 230 in the embodiment corresponding to FIG. 2.

Step 340: A position of a first time in point touch control point and a position of a second time in point touch control point of the second operation are determined, wherein the first time in point is earlier than the second time in point.

In this step, the position of the first time in point touch control point and the position of the second time in point touch control point of the second operation are determined, wherein the first time in point is earlier than the second time in point. Specific operations may refer to step 240 in the embodiment corresponding to FIG. 2.

Step 350: A touch control point that is proximal to a vertex of the video window in a Y-coordinate direction is determined in the first time in point touch control point of the first operation first time in point touch control point of the second operation, wherein the vertex of the video window is a point most proximal to a coordinate origin among four points in a plane of the video window.

In this step, the touch control point that is proximal to the vertex of the video window in the Y-coordinate direction is determined in the first time in point touch control point of the first operation first time in point touch control point of the second operation, that is, a position, among the positions of the start touch control points of the two operations, which is more proximal to the vertex of the video window is determined. Alternatively, in the first operation and the second operation, at the same time point, a position, in the two operations, which is more proximal to the vertex of the video window is determined. It may be understood that the vertex of the video window is a point most proximal to a coordinate origin among four points in a plane of the video window. Specifically, the coordinate origin may be defined at the upper left corner of the display screen, and in this case, the vertex of the video window is correspondingly located at the upper left corner of the video window. However, the coordinate origin may be defined at the lower left corner of the display screen, and in this case, the vertex of the video window is correspondingly located at the lower left corner of the video window. The embodiment of the present disclosure sets no limitation thereto.

Step 360: A position change of the video window in the Y-coordinate direction is determined according to a position change of the touch control point that is proximal to the vertex of the video window in the Y-coordinate direction.

In this step, the position change of the video window in the Y-coordinate direction is determined according to the position change of the touch control point that is proximal to the vertex of the video window in the Y-coordinate direction. That is, when the touch control point that is proximal to the vertex of the video window in the Y-coordinate direction moves towards a direction, the video window also moves towards to this direction. Specifically, when the touch control point that is proximal to the vertex of the video window in the Y-coordinate direction moves towards a direction by a specific value, the video window also moves towards to this direction by the specific value. It may be understood that, in the present disclosure, the position change of the video window in the Y-coordinate direction is determined according to a position change of the touch control point that is distal from the vertex of the video window in the Y-coordinate direction. This manner is similar to the above manner. For brevity of description, this manner is not described herein in the embodiment of the present invention.

In the embodiment of the present disclosure, the position change of the video window in the Y-coordinate direction is determined according to the position change of the touch control point that is proximal to the vertex of the video window in the Y-coordinate direction, such that the video window is dragged by means of multi-touch control.

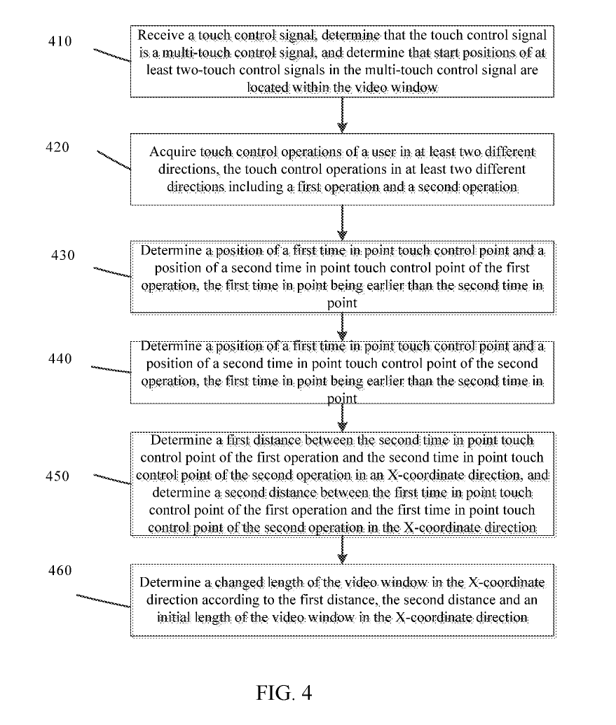

FIG. 4 is a flowchart illustrating a method for adjusting a video window based on multi-touch control according to some embodiments of the present disclosure. As illustrated in FIG. 4, the method for adjusting a video window based on multi-touch control according to the embodiment of the present disclosure includes the following steps:

Step 410: A touch control signal is received, it is determined that the touch control signal is a multi-touch control signal, and it is determined that start positions of at least two-touch control signals in the multi-touch control signal are located within the video window.

In this step, the touch control signal is received, the touch control signal is determined to be a multi-touch control signal, and it is determined that the start positions of at least two-touch control signals in the multi-touch control signal are located within the video window. Specific operations may refer to step 110 in the embodiment corresponding to FIG. 1.

Step 420: Touch control operations of a user in at least two different directions are acquired, wherein the touch control operations in at least two different directions include a first operation and a second operation.

In this step, the touch control operations of a user in at least two different directions are acquired, wherein the touch control operations in at least two different directions include a first operation and a second operation. Specific operations may refer to step 120 in the embodiment corresponding to FIG. 1.

Step 430: A position of a first time in point touch control point and a position of a second time in point touch control point of the first operation are determined, wherein the first time in point is earlier than the second time in point.

In this step, the position of the first time in point touch control point and the position of the second time in point touch control point of the first operation are determined, wherein the first time in point is earlier than the second time in point. Specific operations may refer to step 230 in the embodiment corresponding to FIG. 2.

Step 440: A position of a first time in point touch control point and a position of a second time in point touch control point of the second operation are determined, wherein the first time in point is earlier than the second time in point.

In this step, the position of the first time in point touch control point and the position of the second time in point touch control point of the second operation are determined, wherein the first time in point is earlier than the second time in point. Specific operations may refer to step 240 in the embodiment corresponding to FIG. 2.

Step 450: A first distance between the second time in point touch control point of the first operation and the second time in point touch control point of the second operation in an X-coordinate direction is determined, and a second distance between the first time in point touch control point of the first operation and the first time in point touch control point of the second operation in the X-coordinate direction is determined.

In this step, the first distance between the second time in point touch control point of the first operation and the second time in point touch control point of the second operation in the X-coordinate direction is determined. It may be understood that the distance between the second time in point touch control point of the first operation and the second time in point touch control point of the second operation in the X-coordinate direction is a distance between the positions where two fingers of the user reside at the second time in point in the X-coordinate direction.

In this step, the second distance between the first time in point touch control point of the first operation and the first time in point touch control point of the second operation in the X-coordinate direction is determined. It may be understood that the distance between the first time in point touch control point of the first operation and the first time in point touch control point of the second operation in the X-coordinate direction is a distance between the positions where two fingers of the user reside at the first time in point in the X-coordinate direction.

By comparison of the second distance with the first distance, it may be seen that changes of the positions where the fingers of the user touch are intended to zoom in and zoom out the video window.

When the second distance is greater than the first distance, the user desires to zoom in the video window in the X-coordinate direction, and when the second distance is less than the first distance, the user desires to zoom out the video window in the X-coordinate direction.

Step 460: A changed length of the video window in the X-coordinate direction is determined according to the first distance, the second distance and an initial length of the video window in the X-coordinate direction.

By comparison of the second distance with the first distance, it may be seen that changes of the positions where the fingers of the user touch are intended to zoom in and zoom out the video window. Therefore, in this step, the changed length of the video window in the X-coordinate direction is determined according to the first distance, the second distance and an initial length of the video window in the X-coordinate direction.

Specifically, in this step, the determining a changed length of the video window in the X-coordinate direction according to the first distance, the second distance and an initial length of the video window in the X-coordinate direction includes:

calculating a ratio of the first distance to the second distance, and using a product of the ratio and the initial length of the video window in the X-coordinate direction as changed length of the video window in the X-coordinate direction.

That is, a ratio of the subsequent distance between two fingers of the user to the initial distance of the fingers of the user is used as a ratio of the changes of the video window in the X-coordinate direction.

Alternatively, the determining a changed length of the video window in the X-coordinate direction according to the first distance, the second distance and an initial length of the video window in the X-coordinate direction includes: calculating a difference between the first distance and the second distance, and using a sum of the difference and the initial length of the video window in the X-coordinate direction as the changed length of the video window in the X-coordinate direction.

That is, a difference of the subsequent distance between two fingers of the user to the initial distance of the fingers of the user is used as a difference of the changes of the video window in the X-coordinate direction.

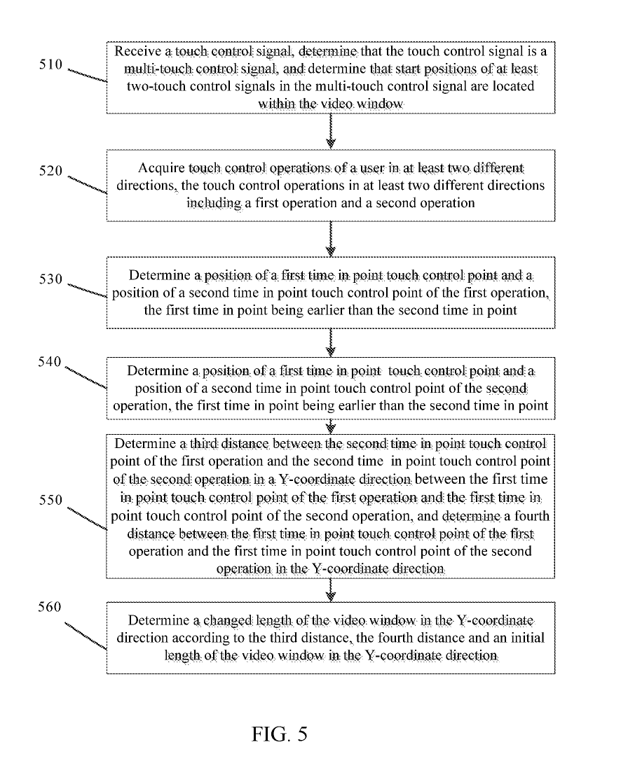

FIG. 5 is a flowchart illustrating a method for adjusting a video window based on multi-touch control according to some embodiments of the present disclosure. As illustrated in FIG. 5, the method for adjusting a video window based on multi-touch control according to the embodiment of the present disclosure includes the following steps:

Step 510: A touch control signal is received, it is determined that the touch control signal is a multi-touch control signal, and it is determined that start positions of at least two-touch control signals in the multi-touch control signal are located with the video window.

In this step, the touch control signal is received, the touch control signal is determined to be a multi-touch control signal, and it is determined that the start positions of at least two-touch control signals in the multi-touch control signal are located within the video window. Specific operations may refer to step 110 in the embodiment corresponding to FIG. 1.

Step 520: Touch control operations of a user in at least two different directions are acquired, wherein the touch control operations in at least two different directions include a first operation and a second operation.

In this step, the touch control operations of a user in at least two different directions are acquired, wherein the touch control operations in at least two different directions include a first operation and a second operation. Specific operations may refer to step 120 in the embodiment corresponding to FIG. 1.

Step 530: A position of a first time in point touch control point and a position of a second time in point touch control point of the first operation are determined, wherein the first time in point is earlier than the second time in point.

In this step, the position of the first time in point touch control point and the position of the second time in point touch control point of the first operation are determined, wherein the first time in point is earlier than the second time in point. Specific operations may refer to step 230 in the embodiment corresponding to FIG. 2.

Step 540: A position of a first time in point touch control point and a position of a second time in point touch control point of the second operation are determined, wherein the first time in point is earlier than the second time in point.

In this step, the position of the first time in point touch control point and the position of the second time in point touch control point of the second operation are determined, wherein the first time in point is earlier than the second time in point. Specific operations may refer to step 240 in the embodiment corresponding to FIG. 2.

Step 550: A third distance between the second time in point touch control point of the first operation and the second time in point touch control point of the second operation in a Y-coordinate direction is determined, and a fourth distance between the first time in point touch control point of the first operation and the first time in point touch control point of the second operation in the Y-coordinate direction is determined.

In this step, the third distance between the second time in point touch control point of the first operation and the second time in point touch control point of the second operation in the Y-coordinate direction is determined. It may be understood that the distance between the second time in point touch control point of the first operation and the second time in point touch control point of the second operation in the Y-coordinate direction is a distance between the positions where two fingers of the user reside at the second time in point in the Y-coordinate direction.

In this step, the fourth distance between the first time in point touch control point of the first operation and the first time in point touch control point of the second operation in the Y-coordinate direction is determined. It may be understood that the distance between the first time in point touch control point of the first operation and the first time in point touch control point of the second operation in the Y-coordinate direction is a distance between the positions where two fingers of the user reside at the first time in point in the Y-coordinate direction.

By comparison of the fourth distance with the third distance, it may be seen that changes of the positions where the fingers of the user touch are intended to zoom in and zoom out the video window.

When the fourth distance is greater than the third distance, the user desires to zoom in the video window in the U-coordinate direction, and when the fourth distance is less than the third distance, the user desires to zoom out the video window in the Y-coordinate direction.

Step 560: A changed length of the video window in the X-coordinate direction is determined according to the third distance, the fourth distance and an initial length of the video window in the X-coordinate direction.

By comparison of the fourth distance with the third distance, it may be seen that changes of the positions where the fingers of the user touch are intended to zoom in and zoom out the video window. Therefore, in this step, the changed length of the video window in the Y-coordinate direction is determined according to the third distance, the fourth distance and an initial length of the video window in the Y-coordinate direction.

Alternatively, the determining a changed length of the video window in the Y-coordinate direction according to the third distance, the fourth distance and an initial length of the video window in the Y-coordinate direction includes: calculating a ratio of the third distance to the fourth distance, and using a product of the ratio and the initial length of the video window in the Y-coordinate direction as the changed length of the video window in the Y-coordinate direction.

That is, a ratio of the subsequent distance between two fingers of the user to the initial distance of the fingers of the user is used as a ratio of the changes of the video window in the Y-coordinate direction.

Alternatively, the determining a changed length of the video window in the Y-coordinate direction according to the third distance, the fourth distance and an initial length of the video window in the Y-coordinate direction includes: calculating a difference between the third distance and the fourth distance, and using a sum of the difference and the initial length of the video window in the Y-coordinate direction as the changed length of the video window in the Y-coordinate direction.

That is, a difference of the subsequent distance between two fingers of the user to the initial distance of the fingers of the user is used as a difference of the changes of the video window in the Y-coordinate direction.

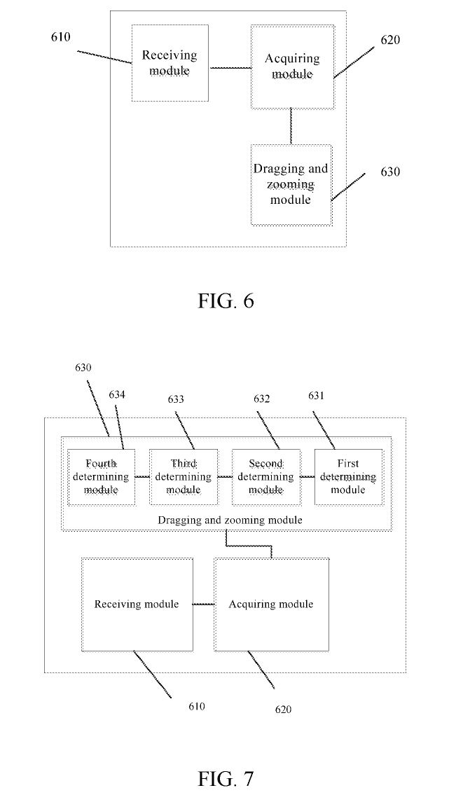

FIG. 6 is a schematic structural diagram illustrating an electronic device for use in adjusting a video window based on multi-touch control according to some embodiments of the present disclosure. as illustrated in FIG. 6, the electronic device for use in adjusting a video window based on multi-touch control according to the embodiment of the present disclosure includes: a receiving module 610, an acquiring module 620 and a dragging and zooming module 630.

The receiving module 610 is configured to receive a touch control signal, determine that the touch control signal is a multi-touch control signal, and determine that start positions of at least two-touch control signals in the multi-touch control signal are located with the video window.

Specific operations performed by the receiving module 610 may refer to step 110 in the embodiment corresponding to FIG. 1.

The acquiring module 620 is configured to acquire touch control operations of a user in at least two different directions, wherein the touch control operations in at least two different directions include a first operation and a second operation.

Specific operations performed by the acquiring module 620 may refer to step 120 in the embodiment corresponding to FIG. 1.

The dragging and zooming module 630 is configured to drag and zoom the video window according to the touch control operations in the two different directions.

Specific operations performed by the dragging and zooming module 630 may refer to step 130 in the embodiment corresponding to FIG. 1.

With the method for adjusting a video window based on multi-touch control according to the embodiment of the present disclosure, touch control stretching and zooming of the size and position of a small window during video calls are monitored, such that the video calls are simpler, and thus the user may make more humanized feedbacks according to the user's operations as desired.

FIG. 6 is a schematic structural diagram illustrating an electronic device for use in adjusting a video window based on multi-touch control according to some embodiments of the present disclosure. As illustrated in FIG. 7, the electronic device for use in adjusting a video window based on multi-touch control according to the embodiment of the present disclosure includes: a receiving module 610, an acquiring module 620 and a dragging and zooming module 630; wherein specific operations of the modules in this embodiment may refer to the corresponding modules in the embodiment corresponding to FIG. 6.

The dragging and zooming module 630 includes:

a first determining module 631, configured to determine a position of a first time in point touch control point and a position of a second time in point touch control point of the first operation, wherein the first time in point is earlier than the second time in point;

specific operations performed by the first determining module 631 may refer to step 230 in the embodiment corresponding to FIG. 2;

a second determining module 632, configured to determine a position of a first time in point touch control point and a position of a second time in point touch control point of the second operation, wherein the first time in point is earlier than the second time in point;

specific operations performed by the second determining module 632 may refer to step 240 in the embodiment corresponding to FIG. 2;

a third determining module 633, configured to determine, in the first time in point touch control point of the first operation first time in point touch control point of the second operation, a touch control point that is proximal to a vertex of the video window in an X-coordinate direction, wherein the vertex of the video window is a point most proximal to a coordinate origin among four points in a plane of the video window;

specific operations performed by the third determining module 633 may refer to step 250 in the embodiment corresponding to FIG. 2; and

a fourth determining module 634, configured to determine a position change of the video window in the X-coordinate direction according to a position change of the touch control point that is proximal to the vertex of the video window in the X-coordinate direction;

specific operations performed by the fourth determining module 634 may refer to step 260 in the embodiment corresponding to FIG. 2.

In the embodiment of the present disclosure, the position change of the video window in the X-coordinate direction is determined according to the position change of the touch control point that is proximal to the vertex of the video window in the X-coordinate direction, such that the video window is dragged by means of multi-touch control.

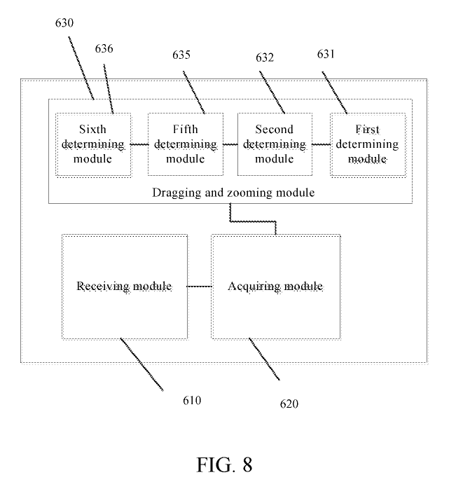

FIG. 8 is a schematic structural diagram illustrating an electronic device for use in adjusting a video window based on multi-touch control according to some embodiments of the present disclosure. As illustrated in FIG. 8, the electronic device for use in adjusting a video window based on multi-touch control according to the embodiment of the present disclosure includes: a receiving module 610, an acquiring module 620 and a dragging and zooming module 630; wherein specific operations of the modules in this embodiment may refer to the corresponding modules in the embodiment corresponding to FIG. 6.

The dragging and zooming module 630 includes:

a first determining module 631, configured to determine a position of a first time in point touch control point and a position of a second time in point touch control point of the first operation, wherein the first time in point is earlier than the second time in point;

specific operations performed by the first determining module 631 may refer to step 230 in the embodiment corresponding to FIG. 2;

a second determining module 632, configured to determine a position of a first time in point touch control point and a position of a second time in point touch control point of the second operation, wherein the first time in point is earlier than the second time in point;

specific operations performed by the second determining module 632 may refer to step 240 in the embodiment corresponding to FIG. 2;

a fifth determining module 635, configured to determine, in the first time in point touch control point of the first operation first time in point touch control point of the second operation, a touch control point that is proximal to a vertex of the video window in a Y-coordinate direction, wherein the vertex of the video window is a point most proximal to a coordinate origin among four points in a plane of the video window; and

specific operations performed by the fifth determining module 635 may refer to step 350 in the embodiment corresponding to FIG. 3;

a sixth determining module 636, configured to determine a position change of the video window in the Y-coordinate direction according to a position change of the touch control point that is proximal to the vertex of the video window in the Y-coordinate direction;

specific operations performed by the sixth determining module 636 may refer to step 360 in the embodiment corresponding to FIG. 3.

In the embodiment of the present disclosure, the position change of the video window in the Y-coordinate direction is determined according to the position change of the touch control point that is proximal to the vertex of the video window in the Y-coordinate direction, such that the video window is dragged by means of multi-touch control.

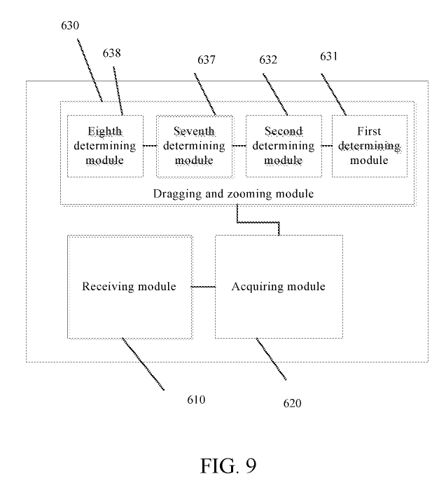

FIG. 9 is a schematic structural diagram illustrating an electronic device for use in adjusting a video window based on multi-touch control according to some embodiments of the present disclosure. As illustrated in FIG. 9, the electronic device for use in adjusting a video window based on multi-touch control according to the embodiment of the present disclosure includes: a receiving module 610, an acquiring module 620 and a dragging and zooming module 630; wherein specific operations of the modules in this embodiment may refer to the corresponding modules in the embodiment corresponding to FIG. 6.

The dragging and zooming module 630 includes:

a first determining module 631, configured to determine a position of a first time in point touch control point and a position of a second time in point touch control point of the first operation, wherein the first time in point is earlier than the second time in point;

specific operations performed by the first determining module 631 may refer to step 230 in the embodiment corresponding to FIG. 2;

a second determining module 632, configured to determine a position of a first time in point touch control point and a position of a second time in point touch control point of the second operation, wherein the first time in point is earlier than the second time in point;

specific operations performed by the second determining module 632 may refer to step 240 in the embodiment corresponding to FIG. 2;

a seventh determining module 637, configured to determine a first distance between the second time in point touch control point of the first operation and the second time in point touch control point of the second operation in an X-coordinate direction is determined, and determine a second distance between the first time in point touch control point of the first operation and the first time in point touch control point of the second operation in the X-coordinate direction;

specific operations performed by the seventh determining module 637 may refer to step 450 in the embodiment corresponding to FIG. 4; and

an eighth determining module 638, configured to determine a changed length of the video window in the X-coordinate direction according to the first distance, the second distance and an initial length of the video window in the X-coordinate direction;

specific operations performed by the seventh determining module 638 may refer to step 450 in the embodiment corresponding to FIG. 4.

Specifically, the eighth determining module 638 includes: an X-coordinate change determining module, configured to calculate a ratio of the first distance to the second distance, and use a product of the ratio and the initial length of the video window in the X-coordinate direction as changed length of the video window in the X-coordinate direction; or

the eighth determining module 638 includes: a Y-coordinate change determining module, configured to calculate a difference between the first distance and the second distance, and use a sum of the difference and the initial length of the video window in the X-coordinate direction as changed length of the video window in the X-coordinate direction.

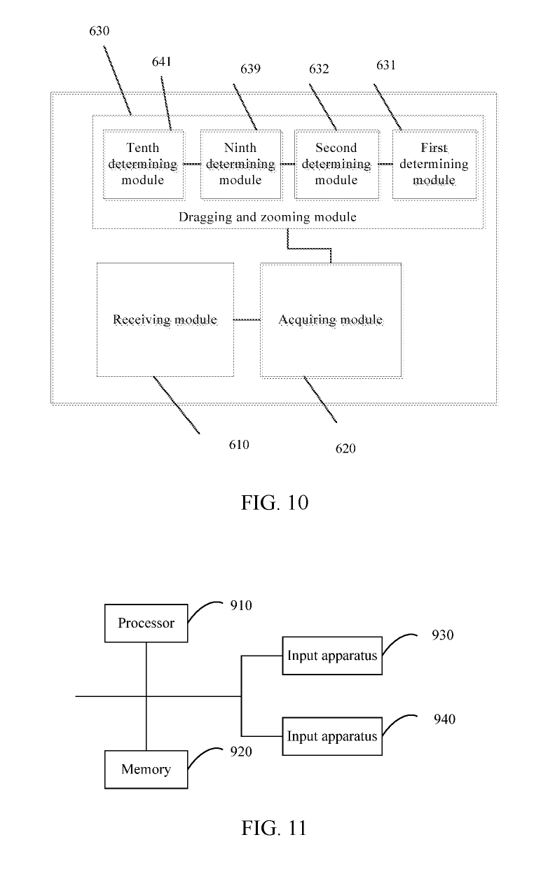

FIG. 10 is a schematic structural diagram illustrating an electronic device for use in adjusting a video window based on multi-touch control according to some embodiments of the present disclosure. As illustrated in FIG. 10, the electronic device for use in adjusting a video window based on multi-touch control according to the embodiment of the present disclosure includes: a receiving module 610, an acquiring module 620 and a dragging and zooming module 630; wherein specific operations of the modules in this embodiment may refer to the corresponding modules in the embodiment corresponding to FIG. 6.

The dragging and zooming module 630 includes:

a first determining module 631, configured to determine a position of a first time in point touch control point and a position of a second time in point touch control point of the first operation, wherein the first time in point is earlier than the second time in point;

specific operations performed by the first determining module 631 may refer to step 230 in the embodiment corresponding to FIG. 2;

a second determining module 632, configured to determine a position of a first time in point touch control point and a position of a second time in point touch control point of the second operation, wherein the first time in point is earlier than the second time in point;

specific operations performed by the second determining module 632 may refer to step 240 in the embodiment corresponding to FIG. 2;

a ninth determining module 639, configured to determine a third distance between the second time in point touch control point of the first operation and the second time in point touch control point of the second operation in a Y-coordinate direction is determined, and determine a fourth distance between the first time in point touch control point of the first operation and the first time in point touch control point of the second operation in the Y-coordinate direction;

specific operations performed by the ninth determining module 639 may refer to step 550 in the embodiment corresponding to FIG. 5.

a tenth determining module 641, configured to determine a changed length of the video window in the Y-coordinate direction according to the third distance, the fourth distance and an initial length of the video window in the Y-coordinate direction;

specific operations performed by the tenth determining module 641 may refer to step 560 in the embodiment corresponding to FIG. 5.

Specifically, the tenth determining module 641 includes: a Y-coordinate change determining module, configured to calculate a ratio of the third distance to the fourth distance, and use a product of the ratio and the initial length of the video window in the Y-coordinate direction as changed length of the video window in the Y-coordinate direction; or

the tenth determining module 641 includes: an X-coordinate change determining module, configured to calculate a difference between the third distance and the fourth distance, and use a sum of the difference and the initial length of the video window in the Y-coordinate direction as changed length of the video window in the Y-coordinate direction.

For ease of understanding, the embodiments of the present disclosure are described with more specific examples.

Firstly, it is monitored whether the press points of two fingers during the video call are within the small window video region. If the press points of two fingers are not within the small window video region, no stretching and zooming is performed for the video window, and if the press points of two fingers are within the small window video region, the movement of the two fingers is monitored.

The following values may be obtained:

Known: coordinates (x, y) of the original small video window, and width w and height h

The following values may be obtained by means of monitoring:

Coordinate a0 (x0, y0) of the position where finger A presses down, coordinate b0 (x00, y00) of the position where finger B presses down, coordinate a1 (x1, y1) of the position where finger A constantly moves, coordinate b1 (x11, y11) of the position where finger B constantly moves, coordinate a2 (x2, y2) of the position where finger A releases the press operation, and coordinate b2 (x22, y22) of the position where finger B releases the press operation

It may be calculated according to the above information:

A comparison is made between x, x0 and x00, with respect to a point which is proximal to x, a subsequent movement changes the position of the x coordinate. (That is, the value of x0−x is compared with the value of x00−x).

A comparison is made between y, y0 and y00, with respect to a point which is proximal to y, a subsequent movement changes the position of the y coordinate. (That is, the value of y0−y is compared with the value of y00−y).

Assume that x00 is proximal to x, x11−x00+x is used as the x coordinate.

When x11−x00<0 and x1−x0>0, the width is calculated based on x1−x0+|x11−x00|+w.

When x11−x00>0 and x1−x0<0, the width is calculated based on w−(x11−x00)−|x1−x0|.

When x11−x00>0 and x1−x0>0, the width is calculated based on (x1−x0)−(x11−x00)+w.

When x11−x00<0 and x1−x0<0, the width is calculated based on (x1−x0)−(x11−x00)+w.

Assume that y0 is proximal to y, y1−y0+y is used as the Y coordinate.

When y1−y0<0 and y11−y00>0, the height is calculated based on |y1−y0|+y11−y00+h.

When y1−y0>0 and y11−y00<0, the height is calculated based on h−(y1−y0)−|y11−y00|.

When y1−y0>0 and y11−y00>0, the height is calculated based on (y11−y00)−(y1−y0)+h

When y1−y0<0 and y11−y00<0, the height is calculated based on (y11−y00)−(y1−y0)+h.

Hence, the small video window is drawn according to the calculated x, y, w and h.

Some embodiments of the present disclosure provides a non-volatile computer storage medium storing computer executable instructions, wherein the computer executable instructions may be used to perform the video program interaction method in any one of the method embodiments.

FIG. 11 is a schematic structural diagram illustrating hardware of an electronic device for performing the method for adjusting a video window based on multi-touch control according to some embodiments of the present disclosure.

As illustrated in FIG. 11, the electronic device includes at least one processor 910 and a memory 920, and FIG. 11 uses one processor 910 as an example.

The electronic device for performing the method for adjusting a video window based on multi-touch control may further include: an input device 930 and an output device 940.

The processor 910, the memory 920, the input apparatus 930 and the output apparatus 940 may be connected to each other via a bus or in another manner. FIG. 11 uses connection via a bus as an example for description.

The memory 920, as a non-volatile computer readable storage medium, may be configured to store non-volatile software programs, non-volatile computer executable programs and modules, for example, the program instructions/modules corresponding to the methods for adjusting a video window based on multi-touch control in the embodiments of the present disclosure (for example, the acquiring module 620 as illustrated in FIG. 6). The non-volatile software programs, instructions and modules stored in the memory 920, when being executed, cause the processor 910 to perform various function application and data processing of a server, that is, performing the methods for adjusting a video window based on multi-touch control in the above method embodiments.

The memory 920 may also include a program storage area and a data storage area. The program storage area may store an operating system and an application implementing at least one function. The data storage area may data created according to use of the electronic device for use in adjusting a video window based on multi-touch control. In addition, the memory 920 may include a high speed random access memory, or include a non-volatile memory, for example, at least one disk storage device, a flash memory device, or another non-volatile solid storage device. In some embodiments, the memory 920 optionally includes memories remotely configured relative to the processor 910. These memories may be connected to the apparatus for adjusting a video window based on multi-touch control. The above examples include, but not limited to, the Internet, Intranet, local area network, mobile communication network and a combination thereof.

The input apparatus 930 may receive input digital or character information, and generate signal input related to user settings and function control of the electronic device for adjusting a video window based on multi-touch control. The output apparatus 940 may include a display screen or the like display device.

One or more modules are stored in the memory 920, and when being executed by the at least one processors 910, perform the method for adjusting a video window based on multi-touch control in any of the above method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

The electronic device in the embodiments of the present disclosure is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad.

(3) a portable entertainment device: which displays and plays multimedia content; such devices include: an audio or video player (for example, an iPod), a palm game machine, an electronic book, and a smart toy, and a portable vehicle-mounted navigation device.

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device.

(5) another electronic device having the data interaction function.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A method for adjusting a video window based on multi-touch control, applied to a touch control device, the method comprising:
receiving a touch control signal, determining that the touch control signal is a multi-touch control signal, and determining that start positions of at least two-touch control signals in the multi-touch control signal are located within the video window;
acquiring touch control operations of a user in at least two different directions, the touch control operations in at least two different directions comprising a first operation and a second operation; and
dragging and zooming the video window according to the touch control operations in the two different directions.

2. The method according to claim 1, wherein the dragging and zooming the video window according to the touch control operations in the two different directions comprises:
determining a position of a first time in point touch control point and a position of a second time in point touch control point of the first operation, the first time in point being earlier than the second time in point;
determining a position of a first time in point touch control point and a position of a second time in point touch control point of the second operation, the first time in point being earlier than the second time in point;
determining a touch control point that is proximal to a vertex of the video window in an X-coordinate direction between the first time in point touch control point of the first operation and the first time in point touch control point of the second operation, the vertex of the video window being a point most proximal to a coordinate origin among four points in a plane of the video window; and
determining a position change of the video window in the X-coordinate direction according to a position change of the touch control point that is proximal to the vertex of the video window in the X-coordinate direction.

3. The method according to claim 1, wherein the dragging and zooming the video window according to the touch control operations in the two different directions comprises:
determining a touch control position at first time in point and a touch control position at second time in point of the first operation, the first time in point being earlier than the second time in point;
determining a position of a first time in point touch control point and a position of a second time in point touch control point of the second operation, the first time in point being earlier than the second time in point;
determining a touch control point that is proximal to a vertex of the video window in a Y-coordinate direction between the first time in point touch control point of the first operation and the first time in point touch control point of the second operation, the vertex of the video window being a point most proximal to a coordinate origin among four points in a plane of the video window; and
determining a position change of the video window in the Y-coordinate direction according to a position change of the touch control point that is proximal to the vertex of the video window in the Y-coordinate direction.

4. The method according to claim 1, wherein the controlling the video window according to the touch control operations in the two different directions comprises:
determining a position of a first time in point touch control point and a position of a second time in point touch control point of the first operation, the first time in point being earlier than the second time in point;
determining a position of a first time in point touch control point and a position of a second time in point touch control point of the second operation, the first time in point being earlier than the second time in point;
determining a first distance between the second time in point touch control point of the first operation and the second time in point touch control point of the second operation in an X-coordinate direction, and determining a second distance between the first time in point touch control point of the first operation and the first time in point touch control point of the second operation in the X-coordinate direction; and
determining a changed length of the video window in the X-coordinate direction according to the first distance, the second distance and an initial length of the video window in the X-coordinate direction.

5. The method according to claim 4, wherein the determining a changed length of the video window in the X-coordinate direction according to the first distance, the second distance and an initial length of the video window in the X-coordinate direction comprises:
calculating a ratio of the first distance to the second distance, and using a product of the ratio and the initial length of the video window in the X-coordinate direction as the changed length of the video window in the X-coordinate direction; or
calculating a difference between the first distance and the second distance, and using a sum of the difference and the initial length of the video window in the X-coordinate direction as the changed length of the video window in the X-coordinate direction.

6. The method according to claim 1, wherein the zooming the video window according to the touch control operations in the two different directions comprises:
determining a position of a first time in point touch control point and a position of a second time in point touch control point of the first operation, the first time in point being earlier than the second time in point;
determining a position of a first time in point touch control point and a position of a second time in point touch control point of the second operation, the first time in point being earlier than the second time in point;
determining a third distance between the second time in point touch control point of the first operation and the second time in point touch control point of the second operation in a Y-coordinate direction, and determining a fourth distance between the first time in point touch control point of the first operation and the first time in point touch control point of the second operation in the Y-coordinate direction; and
determining a changed length of the video window in the Y-coordinate direction according to the third distance, the fourth distance and an initial length of the video window in the Y-coordinate direction.

7. The method according to claim 6, wherein the determining a changed length of the video window in the Y-coordinate direction according to the third distance, the fourth distance and an initial length of the video window in the Y-coordinate direction comprises:
calculating a ratio of the third distance to the fourth distance, and using a product of the ratio and the initial length of the video window in the Y-coordinate direction as the changed length of the video window in the Y-coordinate direction; or
calculating a difference between the third distance and the fourth distance, and using a sum of the difference and the initial length of the video window in the Y-coordinate direction as the changed length of the video window in the Y-coordinate direction.

8. A non-transitory computer-readable storage medium storing executable instructions that, when executed by an electronic device with a touch-sensitive display, cause the electronic device to:
receive a touch control signal, determine that the touch control signal is a multi-touch control signal, and determine that start positions of at least two-touch control signals in the multi-touch control signal are located within the video window;
acquire touch control operations of a user in at least two different directions, the touch control operations in at least two different directions comprising a first operation and a second operation; and
drag and zoom the video window according to the touch control operations in the two different directions.

9. The non-transitory computer-readable storage medium according to claim 8, wherein the step to drag and zoom the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine, in the first time in point touch control point of the first operation first time in point touch control point of the second operation, a touch control point that is proximal to a vertex of the video window in an X-coordinate direction between the first time in point touch control point of the first operation and the first time in point touch control point of the second operation, the vertex of the video window being a point most proximal to a coordinate origin among four points in a plane of the video window; and
determine a position change of the video window in the X-coordinate direction according to a position change of the touch control point that is proximal to the vertex of the video window in the X-coordinate direction.

10. The non-transitory computer-readable storage medium according to claim 8, wherein the step to drag and zoom the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine, in the first time in point touch control point of the first operation and the first time in point touch control point of the second operation, a touch control point that is proximal to a vertex of the video window in a Y-coordinate direction between the first time in point touch control point of the first operation and the first time in point touch control point of the second operation, the vertex of the video window being a point most proximal to a coordinate origin among four points in a plane of the video window; and
determine a position change of the video window in the Y-coordinate direction according to a position change of the touch control point that is proximal to the vertex of the video window in the Y-coordinate direction.

11. The non-transitory computer-readable storage medium according to claim 8, wherein the controlling the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine a first distance between the second time in point touch control point of the first operation and the second time in point touch control point of the second operation in an X-coordinate direction, and determining a second distance between the first time in point touch control point of the first operation and the first time in point touch control point of the second operation in the X-coordinate direction; and
determine a changed length of the video window in the X-coordinate direction according to the first distance, the second distance and an initial length of the video window in the X-coordinate direction.

12. The non-transitory computer-readable storage medium according to claim 8, wherein the determining a changed length of the video window in the X-coordinate direction according to the first distance, the second distance and an initial length of the video window in the X-coordinate direction comprises:
calculate a ratio of the first distance to the second distance, and using a product of the ratio and the initial length of the video window in the X-coordinate direction as changed length of the video window in the X-coordinate direction; or
calculate a difference between the first distance and the second distance, and using a sum of the difference and the initial length of the video window in the X-coordinate direction as changed length of the video window in the X-coordinate direction.

13. The non-transitory computer-readable storage medium according to claim 8, wherein the zooming the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine a third distance between the second time in point touch control point of the first operation and the second time in point touch control point of the second operation in a Y-coordinate direction, and determining a fourth distance between the first time in point touch control point of the first operation and the first time in point touch control point of the second operation in the Y-coordinate direction; and
determine a changed length of the video window in the Y-coordinate direction according to the third distance, the fourth distance and an initial length of the video window in the Y-coordinate direction.

14. The non-transitory computer-readable storage medium according to claim 8, wherein the determining a changed length of the video window in the Y-coordinate direction according to the third distance, the fourth distance and an initial length of the video window in the Y-coordinate direction comprises:
calculate a ratio of the third distance to the fourth distance, and using a product of the ratio and the initial length of the video window in the Y-coordinate direction as changed length of the video window in the Y-coordinate direction; or
calculate a difference between the third distance and the fourth distance, and using a sum of the difference and the initial length of the video window in the Y-coordinate direction as the changed length of the video window in the Y-coordinate direction.

15. An electronic device, comprising:
at least one processor; and
a memory communicably connected with the at least one processor for storing instructions executable by the at least one processor, wherein execution of the instructions by the at least one processor causes the at least one processor to:
receive a touch control signal, determine that the touch control signal is a multi-touch control signal, and determine that start positions of at least two-touch control signals in the multi-touch control signal are located within the video window;
acquire touch control operations of a user in at least two different directions, the touch control operations in at least two different directions comprising a first operation and a second operation; and
drag and zoom the video window according to the touch control operations in the two different directions.

16. The electronic device according to claim 15, wherein the step to drag and zoom the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine, in the first time in point touch control point of the first operation first time in point touch control point of the second operation, a touch control point that is proximal to a vertex of the video window in an X-coordinate direction between the first time in point touch control point of the first operation and the first time in point touch control point of the second operation, the vertex of the video window being a point most proximal to a coordinate origin among four points in a plane of the video window; and
determine a position change of the video window in the X-coordinate direction according to a position change of the touch control point that is proximal to the vertex of the video window in the X-coordinate direction.

17. The electronic device according to claim 15, wherein the dragging and zooming the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine, in the first time in point touch control point of the first operation first time in point touch control point of the second operation, a touch control point that is proximal to a vertex of the video window in a Y-coordinate direction between the first time in point touch control point of the first operation and the first time in point touch control point of the second operation, the vertex of the video window being a point most proximal to a coordinate origin among four points in a plane of the video window; and
determine a position change of the video window in the Y-coordinate direction according to a position change of the touch control point that is proximal to the vertex of the video window in the Y-coordinate direction.

18. The electronic device according to claim 15, wherein the controlling the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine a first distance between the second time in point touch control point of the first operation and the second time in point touch control point of the second operation in an X-coordinate direction, and determining a second distance between the first time in point touch control point of the first operation and the first time in point touch control point of the second operation in the X-coordinate direction; and
determine a changed length of the video window in the X-coordinate direction according to the first distance, the second distance and an initial length of the video window in the X-coordinate direction.

19. The electronic device according to claim 15, wherein the determining a changed length of the video window in the X-coordinate direction according to the first distance, the second distance and an initial length of the video window in the X-coordinate direction comprises:
calculate a ratio of the first distance to the second distance, and using a product of the ratio and the initial length of the video window in the X-coordinate direction as changed length of the video window in the X-coordinate direction; or
calculate a difference between the first distance and the second distance, and using a sum of the difference and the initial length of the video window in the X-coordinate direction as changed length of the video window in the X-coordinate direction.

20. The electronic device according to claim 15, wherein the zooming the video window according to the touch control operations in the two different directions comprises:
determine a position of a first time in point touch control point and a position of a second time in point touch control point of the first operation, the first time in point being earlier than the second time in point;
determine a position of a first time in point touch control point and a position of a second time in point touch control point of the second operation, the first time in point being earlier than the second time in point;
determine a third distance between the second time in point touch control point of the first operation and the second time in point touch control point of the second operation in a Y-coordinate direction, and determining a fourth distance between the first time in point touch control point of the first operation and the first time in point touch control point of the second operation in the Y-coordinate direction; and
determine a changed length of the video window in the Y-coordinate direction according to the third distance, the fourth distance and an initial length of the video window in the Y-coordinate direction.

21. The electronic device according to claim 15, wherein the determining a changed length of the video window in the Y-coordinate direction according to the third distance, the fourth distance and an initial length of the video window in the Y-coordinate direction comprises:
calculate a ratio of the third distance to the fourth distance, and using a product of the ratio and the initial length of the video window in the Y-coordinate direction as changed length of the video window in the Y-coordinate direction; or
calculate a difference between the third distance and the fourth distance, and using a sum of the difference and the initial length of the video window in the Y-coordinate direction as the changed length of the video window in the Y-coordinate direction.
